(19) United States
(12) Patent Application Publication
(10) Pub. No.: US 2007/0249782 A1
(43) Pub. Date: Oct. 25, 2007

(54) Organopolysiloxanes Comprising Nitrogen and Their Use in Cross-Linkable Materials

(75) Inventors: Uwe Scheim, Coswig (DE); Ernst Selbertinger, Burghausen (DE); Wolfgang Ziche, Burghausen (DE); Christian Ochs, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMICAL CORPORATION, Munich (DE)

(21) Appl. No.: 11/574,086

(22) PCT Filed: Sep. 14, 2005
(86) PCT No.: PCT/EP05/09879

§ 371 Date: Feb. 22, 2007

(30) Foreign Application Priority Data
Sep. 23, 2004 (DE) 10 2004 046 180.5

(51) Int. Cl. C08G 77/54; C08L 83/14

(52) U.S. Cl. 524/588; 528/33

(57) ABSTRACT

Nitrogen-containing organopolysiloxanes which may also contain crosslinkable reactive groups are easily prepared by reaction of an alkoxy-functional oligosilane containing methylene linkages between silyl groups and nitrogen with organopolysiloxanes condensable therewith. The nitrogen may be quaternized if desired. The chain amino nitrogens can subsequently be quaternized if desired. Uses for the products include single component crosslinkable compositions.

The invention relates to nitrogen-containing organopolysiloxanes, to their preparation, and to their use in crosslinkable compositions.

Nitrogen-containing organopolysiloxanes are already known. U.S. Pat. No. 2,567,131, for example, describes cyclic and linear oligomers and polymers composed exclusively of repeating Si—C—N—C—Si—O— units.

Within the field of polyquaternary polysiloxanes which contain the quaternized nitrogen in the siloxane backbone, reference may be made, by way of example, to U.S. Pat. No. 4,533,714, U.S. Pat. No. 6,730,766 or EP 282 720 A1. The quaternary groups are generated by known methods, such as by alkylation with methyl chloride or by the reaction of epoxides with amines. A problematic aspect of such methods is that the amino- or epoxy-polysiloxanes needed are costly and inconvenient to prepare. It is therefore desirable to be able to prepare quaternary polysiloxanes from simple building blocks. None of the above specifications describe compounds which by virtue of crosslinkable groups can be incorporated, during vulcanization, into a polymer matrix likewise equipped with such groups. This is so in particular for compounds which possess silane groups that are crosslinkable through hydrolysis/condensation.

The invention provides organopolysiloxanes comprising at least one unit (a) selected from units (a1) of the formula
O_{1/2}—SiR₂CR¹₂NR²CR¹₂SiR₂—O_{1/2} (I)
and units (a2) of the formula
[O_{1/2}—SiR₂CR¹₂NR³₂CR¹₂SiR₂—O_{1/2}]^{⊕}.X⁻ (VIII);
if desired, units of the formula
O_{1/2}—SiR₂—O_{1/2} (II);
if desired, units of the formula
R⁴O_{1/2} (III);
if desired, units of the formula
R⁵ₙSiR₃₋ₙ—O_{1/2} (IV);
if desired, units of the formula
O_{1/2}SiR₂ (CH₂)ₐNR³₃^{⊕}X⁻ (V);
and, if desired, units of the formula
O_{1/2}SiR₂(CH₂)_{b}NR²₂ (VI)
where
R at each occurrence can be identical or different and is a monovalent, SiC-bonded, optionally substituted hydrocarbon radical,
R¹ at each occurrence can be identical or different and is monovalent organic radicals or hydrogen atom,
R² at each occurrence can be identical or different and is monovalent organic radicals or hydrogen atom,
R³ at each occurrence can be identical or different and is monovalent organic radicals or hydrogen atom,
R⁴ can be identical or different and is hydrogen atom or monovalent, optionally substituted hydrocarbon radicals,
R⁵ at each occurrence can be identical or different and is monovalent hydrolyzable organic radicals attached via oxygen atom or nitrogen atom to silicon atom,
n is 2 or 3,
a is an integer from 1 to 6, preferably 1 to 3, more preferably 1,
b is an integer from 1 to 6, preferably 1 to 3, more preferably 1, and
X⁻ can be identical or different and is an organic or inorganic anion,
with the proviso that in the case of organopolysiloxanes containing no unit of the formula (VIII) there is additionally at least one unit of the formula (II) present, and in the case of organopolysiloxanes containing no unit of the formula (I) there is additionally at least one unit present selected from units of the formula (III) and of the formula (IV).

For the purposes of the present invention the term “organopolysiloxanes” is intended to encompass polymeric, oligomeric, and dimeric siloxanes.

Examples of radicals R are alkyl radicals, such as the methyl, ethyl, n-propyl, isopropyl, n-butyl, sec-butyl, isobutyl, tert-butyl, n-pentyl, isopentyl, neopentyl, tert-pentyl radical; hexyl radicals, such as n-hexyl radical; heptyl radicals, such as n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl radical, and methyl-cyclohexyl radicals; alkenyl radicals, such as the vinyl, 1-propenyl, and the 2-propenyl radical; aryl radicals, such as the phenyl, naphthyl, anthryl, and phenanthryl radical; alkaryl radicals, such as o-, m-, p-tolyl radicals; xylyl radicals and ethylphenyl radicals; and aralkyl radicals, such as the benzyl radical, the α- and the β-phenylethyl radical.

Examples of substituted radicals R are methoxyethyl, ethoxyethyl, (2-ethoxy)ethoxyethyl, 3-chloropropyl, 2-chloro-ethyl, chloromethyl, and the 3,3,3-trifluoropropyl radical.

Radical R preferably comprises hydrocarbon radicals having 1 to 12 carbon atoms, which if desired are substituted by halogen atoms, amino groups, ether groups, ester groups, epoxy groups, mercapto groups, cyano groups or (poly)glycol radicals, the latter being composed of oxyethylene and/or oxypropylene units; more preferably, alkyl radicals having 1 to 6 carbon atoms, and in particular the methyl radical.

Examples of radicals R¹ are the examples specified for radicals R, and also hydrogen atom.

Radical R¹ preferably comprises hydrogen atom and also optionally substituted hydrocarbon radicals, more preferably hydrogen atom and alkyl radicals having 1 to 6 carbon atoms, and especially hydrogen atom.

Examples of radicals R² are the examples specified for radical R, and also hydrogen atom.

Radical R² preferably comprises hydrogen atom and also optionally substituted hydrocarbon radicals, more preferably hydrogen atom and alkyl radicals having 1 to 6 carbon atoms, and especially hydrogen atom.

Examples of radicals R³ are the examples specified for radical R, and also hydrogen atom.

Radical R³ preferably comprises optionally substituted hydrocarbon radicals, more preferably alkyl radicals having 1 to 20 carbon atoms, and especially the methyl radical.

Examples of radicals R⁴ are the examples specified for radical R.

Radical R⁴ preferably comprises hydrogen atom and also alkyl radicals having 1 to 6 carbon atoms, hydrogen atom, methyl radical or ethyl radical being particularly preferred, and especially hydrogen atom.

Examples of radicals R⁵ are all hydrolyzable radicals disclosed to date, such as optionally substituted hydrocarbon radicals attached via oxygen atom or nitrogen atom to silicon atom, for example.

Radical R⁵ preferably comprises alkoxy radicals, such as methoxy, ethoxy, n-propoxy, isopropoxy, n-butoxy, isobutoxy, sec-butoxy, tert-butoxy, and 2-methoxyethoxy radical, acyloxy radicals, such as the acetoxy radical, amino radicals, such as methylamino, dimethylamino, ethylamino, diethylamino, and cyclohexylamino radical, amido radicals, such as N-methylacetamido and benzamido radical, amineoxy radicals, such as the diethylamineoxy radical, oximo radicals, such as methyl ethyl ketoximo and methyl isobutyl ketoximo radical, and enoxy radicals, such as the 2-propenoxy radical; more preferably the methoxy, ethoxy, acetoxy, methyl ethyl ketoximo, methyl isobutyl ketoximo, dimethylamino, and cyclohexylamino radical; and in particular the methoxy or ethoxy radical.

Examples of anion X⁻ are organic anions, such as carboxylate ions, enolate ions, and sulfonate ions, and inorganic anions, such as halide ions, such as fluoride ions, chloride ions, bromide ions, and iodide ions, and sulfate ions.

Anion X⁻ preferably comprises carboxylate ions, sulfonate ions, and halide ions, more preferably chloride ions and acetate ions.

Preferably n is 2.

The siloxanes of the invention are preferably liquid and have a viscosity of preferably 10² mPas to 10⁸ mPas at 25° C.

The nitrogen-containing organopolysiloxanes of the invention are preferably of the kind having no units of the formula (VIII) (type A siloxanes), such as, for instance, siloxanes which contain units of the formulae (I) and (II) and also, if desired, units of the formulae (III) to (VI), or are of the kind comprising units of the formula (VIII) (type B siloxanes), such as, for instance, siloxanes containing units of the formula (VIII) and, if desired, units of the formulae (I) to (VI), and in the case of type B siloxanes containing no unit of the formula (I) there being at least one unit present of the formula (III) and/or of the formula (IV).

Examples of the type A siloxanes of the invention are
HO[(SiMe₂O)₃₀₋₁₀₀₀(SiMe₂CH₂NHCH₂SiMe₂O)₁₋₂]₁₋₅(SiMe₂O)₃₀₋₁₀₀₀H,
(MeO)₂MeSiO[(SiMe₂O)₃₀₋₁₀₀₀(SiMe₂CH₂NHCH₂SiMe₂O)₁₋₂]₁₋₅—(SiMe₂O)₃₀₋₁₀₀₀SiMe(OMe)₂,
[[(SiMe₂O)₃₀₋₁₀₀₀(SiMe₂CH₂NHCH₂SiMe₂O)₁₋₂]₁₋₅(SiMe₂O)₃₀₋₁₀₀₀]₁₋₂, and
MeO[(SiMe₂CH₂NHCH₂SiMe₂O)₁₋₂(SiMe₂O)₃₀₋₁₀₀₀—(SiMe₂CH₂NHCH₂SiMe₂O)₁₋₂]₁₋₅Me,
   Me being methyl radical.

The type A siloxanes of the invention are preferably of the kind of the formula
E-[(—O—SiR₂)ₒ—(O—SiR₂CR¹₂NR²CR¹₂SiR₂)ₚ]ᵣ(O—SiR₂)_{q}—OE (VII),
where
E can be identical or different and has one of the definitions specified for R⁴, or is a radical (R⁵)ₙ—SiR₃₋ₙ—,
o can be identical or different and is 0 or an integer from 1 to 3000, preferably 10 to 2000,
q is 0 or an integer from 1 to 3000, preferably 10 to 2000,
p can be identical or different and is an integer from 1 to 20, preferably 1 to 5, more preferably 1, and
r is an integer from 1 to 20, and
R, R¹, R², and n have a definition specified for them above, with the proviso that the sum o+q is greater than or equal to 1, preferably 10 to 2000.

The type A siloxanes of the invention have a viscosity of preferably 10⁵ to 10⁸ mPas at 25° C.

Examples of the type B siloxanes of the invention are
HO[(SiMe₂O)₃₀₋₁₀₀₀(SiMe₂CH₂Me₂N⁺Cl⁻CH₂SiMe₂O)₁₋₂]₁₋₅(SiMe₂O)₃₀₋₁₀₀₀H,
(MeO)₂MeSiO[(SiMe₂O)₃₀₋₁₀₀₀(SiMe₂CH₂Me₂N⁺X⁻CH₂SiMe₂O)₁₋₂]₁₋₅—(SiMe₂O)₃₀₋₁₀₀₀SiMe(OMe)₂,
MeO[(SiMe₂CH₂Me₂N⁺X⁻CH₂SiMe₂O)₁₋₂(SiMe₂O)₃₀₋₁₀₀₀—(SiMe₂CH₂Me₂N⁺X⁻CH₂SiMe₂O)₁₋₂]₁₋₅Me,
HO[(SiMe₂O)₃₀₋₁₀₀₀(SiMe₂CH₂Me (CH₃—CH₂—CH(OH)—CH₂)N⁺X⁻CH₂SiMe₂O)₁₋₂]₁₋₅(SiMe₂O)₃₀₋₁₀₀₀H,
(MeO)₂MeSiO[(SiMe₂O)₃₀₋₁₀₀₀(SiMe₂CH₂Me(CH₃—CH₂—CH(OH)—CH₂)N⁺X⁻CH₂SiMe₂O)₁₋₂]₁₋₅(SiMe₂O)₃₀₋₁₀₀₀SiMe(OMe)₂,
MeO[(SiMe₂CH₂Me(CH₃—CH₂—CH(OH)—CH₂)N⁺X⁻CH₂SiMe₂O)₁₋₂]₁₋₅(SiMe₂O)₃₀₋₁₀₀₀(SiMe₂CH₂Me(CH₃—CH₂—CH(OH)—CH₂)N⁺X⁻CH₂SiMe₂O)₁₋₂]₁₋₅Me,
   Me being methyl radical and X having one of the definitions specified above.

The type B siloxanes of the invention are preferably substantially linear siloxanes, more preferably substantially linear siloxanes composed of at least one unit of the formula (VIII), at least one unit of the formula (III), and, if desired, units of formulae (II), (IV), (V), and (VI), and in particular are of the kind of the formula HO[(SiMe₂O)₀₋₃₀(SiMe₂CH₂ (H₃C)₂N⁺Cl⁻CH₂SiMe₂O)₁₋₂]₁₋₂₀(SiMe₂O)₀₋₃₀H, Me being methyl radical.

The type B siloxanes of the invention have a viscosity of preferably 10² to 5·10⁷ mPas at 25° C.

The organopolysiloxanes of the invention have the advantage that they can be used to prepare crosslinkable compositions, especially particularly low-modulus RTV1 compositions, without the need for separate preparation of polymers at very high viscosity.

The type B organopolysiloxanes of the invention have the advantage that they allow formulations having permanent biostatic properties.

The nitrogen-containing organopolysiloxanes of the invention can be prepared by any desired processes known per se in silicon chemistry, such as by hydrolysis, and condensation of organosilicon compounds.

The siloxanes of the invention preferably come about through reaction of OH-terminated polydiorganosiloxanes with organosilicon compounds of the formulae
R⁴O—SiR₂CR¹₂NR²CR¹₂SiR₂—OR⁴ (IX)
and/or
[R⁴O—SiR₂CR¹₂NR³₂CR¹₂SiR₂—OR⁴]^{⊕}.X⁻ (X)
and also, if desired,
R⁵ₙ₊₁SiR₃₋ₙ (XI);
if desired,
R⁴OSiR₂(CH₂)ₐNR³₃^{⊕}.X⁻ (XII);
and, if desired,
R⁴OSiR₂(CH₂)_{b}NR²₂ (XIII),
R¹, R², R³, R⁴, R⁵, X, a, b, and n having one of the definitions specified for them above.

The type A siloxanes of the invention are preferably prepared by reacting OH-terminated polydiorganosiloxanes with silanes of the formula (IX) and, if desired, (XI).

The type B siloxanes of the invention can be prepared by reacting OH-terminated polydiorganosiloxanes with silanes of the formula (X) and, if desired, (XI) and, if desired, (XII).

The type B siloxanes of the invention are preferably prepared by reacting OH-terminated polydiorganosiloxanes with silanes of the formula (IX) and, if desired, (XI) and subsequently quaternizing the basic nitrogen.

The process of the invention is carried out at temperatures of preferably 0 to 100° C., more preferably 20 to 80° C., and preferably at the pressure of the surrounding atmosphere, i.e., about 900 to 1100 hPa. The process of the invention can alternatively be carried out at higher or lower pressures.

In the process of the invention the molar ratio of the OH groups in the OH-terminated polydiorganosiloxanes employed to the organosilicon compounds of the formula (IX) is preferably 40:1 to 1:10. At a molar ratio between 40:1 up to greater than 4:1 the OH excess present is such, arithmetically, that only part of the OH-terminated polydiorganosiloxane employed can react with the organosilicon compound of the formula (IX) to give type A siloxanes of the invention, while a part of the OH-terminated polydiorganosiloxane employed remains unreacted. From a molar ratio of less than or equal to 4:1 up to greater than 2:1 it is possible, purely arithmetically, for pure siloxanes of type A having OH end groups to form, although in general mixtures of multiply reacted OH polymers and unreacted OH polymers are formed. From a molar ratio of less than 2:1 up to a ratio of 1:1, there is formation of type A siloxanes with end groups which derive from the organosilicon compound (IX). In the case of molar ratios of less than 1:1 to 1:10, the organosilicon compound (IX) is in excess and therefore remains partly unreacted. At a molar ratio of OH groups to organosilicon compound (IX) of exactly 2:1 it is possible for extremely high-viscosity polymers of type A to form, which at least theoretically have no end groups. This last case, however, is not preferred.

Where the process of the invention is carried out using not only the organosilicon compounds of the formula (IX) but also silanes of the formula (XI), the molar ratio of the OH groups in the OH-terminated polydiorganosiloxanes employed to the silane of formula (XI) is preferably 1:1 to 1:100, more preferably 1:10 to 1:50.

The inventive reaction of the OH-terminated polydiorganosiloxane employed with the organosilicon compound of the formula (IX) and, if desired, further organosilicon compounds can take place either in bulk or else in solvents. Suitable solvents to be selected in this context are those which do not interfere with the reaction of the components.

Examples of solvents employed if desired are trimethylsilyl-terminated polydimethylsiloxanes, such as those having a viscosity of 5 to 1000 mPas at 25° C., and hydrocarbons having about 16 to 30 carbon atoms.

The process of the invention is preferably carried out in the absence of solvents, unless said solvents are selected such that they do not have to be separated off after reaction has taken place. For convenient further processing of the type A siloxanes of the invention it can be advantageous to perform the reaction of the OH-terminated polydiorganosiloxane with the compound of formula (IX) in the presence of constituents which are added subsequently, and also for the preparation of crosslinkable mixtures, such as, for example, hydrocarbons having about 16 to 30 carbon atoms or trimethylsilyl-terminated polydimethylsiloxanes which are used as plasticizers in crosslinkable compositions. One of the consequences of this approach is that there is no need to deal with very high-viscosity polymers.

The inventive reaction of the OH-terminated polydiorganosiloxane employed with the organosilicon compound of formula (IX) and, if desired, further organosilicon compounds generally needs no catalyst, which is very advantageous. In contrast, in the case of the reaction with silanes of the formula (XI), the use of a catalyst may be advantageous, particularly if the silanes of the formula (XI) in question are those in which R⁵ is organyloxy radical. The nature and amount employed of the catalysts for this reaction, a reaction commonly termed “end capping”, have already been numerously described.

Examples of catalysts employed if desired in the process of the invention are Brønsted or Lewis acids or bases such as, for example, zinc acetylacetonate, titanium chelates, acidic phosphoric esters, amines, oximes, acetic acid, formic acid, ammonium salts such as dibutylammonium formate, for example, lithium hydroxide, fluorides, and many others.

The silanes employed in the process of the invention are commercially customary products and/or can be prepared by methods which are commonplace in organosilicon chemistry.

The process of the invention has the advantage that it is easy to carry out and can be carried out immediately prior to the further use of the nitrogen-containing siloxanes in the containers intended for the further processing.

The organopolysiloxanes of the invention can be employed for all purposes for which it has also been possible to use organopolysiloxanes to date. In particular they are suitable for preparing crosslinkable compositions.

The invention further provides crosslinkable compositions characterized in that they exhibit organopolysiloxanes (i) comprising

at least one unit (a) selected from units (a1) of the formula
O_{1/2}—SiR₂CR¹₂NR²CR¹₂SiR₂—O_{1/2} (I)
and units (a2) of the formula
[O_{1/2}—SiR₂CR¹₂NR³₂CR¹₂SiR₂—O_{1/2}]^{⊕}.X⁻ (VIII);
if desired, units of the formula
O_{1/2}—SiR₂—O_{1/2} (II);
if desired, units of the formula
R⁴O_{1/2} (III);
if desired, units of the formula
R⁵ₙSiR₃₋ₙ—O_{1/2} (IV);
if desired, units of the formula
O_{1/2}SiR₂(CH₂)ₐNR³₃^{⊕}X⁻ (V);
and, if desired, units of the formula
O_{1/2}SiR₂(CH₂)_{b}NR²₂ (VI)
where
R at each occurrence can be identical or different and is a monovalent, SiC-bonded, optionally substituted hydrocarbon radical,
R¹ at each occurrence can be identical or different and is monovalent organic radicals or hydrogen atom,
R² at each occurrence can be identical or different and is monovalent organic radicals or hydrogen atom,
R³ at each occurrence can be identical or different and is monovalent organic radicals or hydrogen atom,
R⁴ can be identical or different and is hydrogen atom or monovalent, optionally substituted hydrocarbon radicals,
R⁵ at each occurrence can be identical or different and is monovalent hydrolyzable organic radicals attached via oxygen atom or nitrogen atom to silicon atom,
n is 2 or 3,
a is an integer from 1 to 6, preferably 1 to 3, more preferably 1,
b is an integer from 1 to 6, preferably 1 to 3, more preferably 1, and
X⁻ can be identical or different and is an organic or inorganic anion.

The crosslinkable compositions of the invention are preferably compositions which are crosslinkable through condensation reaction.

Particular preference is given to crosslinkable compositions comprising

(i) nitrogen-containing organopolysiloxanes;

if desired,

(ii) crosslinkers;

if desired,

(iii) catalyst;

if desired,

(iv) filler;

if desired,

(v) adhesion promoters;

if desired,

(vi) further substances selected from the group containing plasticizers, stabilizers, antioxidants, flame retardants, photostabilizers, and pigments;

and, if desired,

(vii) crosslinkable polymers different to (i).

These crosslinkable compositions of the invention are preferably one-component compositions. To prepare these one-component compositions it is possible to mix each of the constituents employed with one another in any desired manner known to date. This mixing takes place preferably at room temperature or at a temperature which comes about when the constituents are combined at room temperature without additional heating or cooling, and at the pressure of the surrounding atmosphere, i.e., about 900 to 1100 hPa. If desired, however, this mixing can also take place at higher or lower pressures, for example, at low pressures in order to avoid gas inclusions.

The preparation of the compositions of the invention and their storage take place preferably under substantially water-free conditions, in order to avoid premature reaction of the compositions.

As crosslinkers (ii), employed if desired, it is possible to employ all crosslinkers which have also been employed to date in compensation-crosslinkable compositions. Crosslinker (ii) preferably comprises organyloxysilanes and their partial hydrolyzates, such as, for example, tetraethoxysilane, tetra-isopropoxysilane, tetra-n-propoxysilane, methyltrimethoxysilane, methyltriethoxysilane, n-butyltrimethoxysilane, n-octyltrimethoxysilane, isooctyltrimethoxysilane, vinyltrimethoxysilane, vinyltriethoxysilane, methyltriacetoxysilane, ethyltriacetoxysilane, and methyl- and vinylketoximosilanes, and their partial hydrolyzates, particular preference being given to methyl- and vinyltrimethoxysilane.

If the crosslinkable compositions of the invention contain crosslinkers (ii), the amounts in question are preferably 0.05 to 10 parts by weight, more preferably 0.2 to 5 parts by weight, based in each case on 100 parts by weight of crosslinkable composition.

As catalysts (iii), employed if desired, it is possible to use all of the condensation catalysts that are known to the skilled worker.

Examples of condensation catalysts (iii) are butyl titanates and organotin compounds, such as di-n-butyltin dilaurate and di-n-butyltin diacetate and its reaction products with the alkoxysilanes stated as crosslinkers or adhesion promoters, dialkyltin oxide solutions in the alkoxysilanes stated as crosslinkers or adhesion promoters, preference being given to di-n-butyltin dilaurate and dibutyltin oxide in tetraethoxysilane hydrolyzate, and particular preference being given to dibutyltin oxide in tetraethoxysilane hydrolyzate.

If the crosslinkable compositions of the invention contain catalyst (iii), the amounts involved are preferably 0.01 to 3 parts by weight, preferably 0.05 to 2 parts by weights, based in each case on 100 parts by weight of crosslinkable composition.

As fillers (iv), employed if desired, it is possible to use all of the fillers which have also been employed to date in crosslinkable compositions. Examples of fillers are reinforcing fillers, i.e., fillers having a BET surface area of at least 30 m²/g, such as carbon blacks, fumed silica, precipitated silica, and mixed silicon-aluminum oxides, it being possible for said fillers to have been made water repellent, and also nonreinforcing fillers, i.e., fillers having a BET surface area of less than 30 m²/g, such as powders of quartz, cristobalite, diatomaceous earth, calcium silicate, zirconium silicate, montmorillonites, such as bentonite, zeolites, including the molecular sieves, such as sodium aluminum silicate, metal oxides, such as aluminum oxide or zinc oxide or their mixed oxides, metal hydroxides, such as aluminum hydroxide, barium sulfate, calcium carbonate, gypsum, silicon nitride, silicon carbide, boron nitride, glass powder, carbon powder, and polymer powder, and hollow glass and plastic beads.

Filler (iv) preferably comprises fumed silicas or calcium carbonate or mixtures thereof, particular preference being given to fumed silica having a BET surface area of 150 m²/g and calcium carbonate having BET surface areas of 1 to 40 m²/g.

If the compositions of the invention contain fillers (iv), the amounts involved are preferably 1 to 50 parts by weight, more preferably 2 to 30 parts by weight, based in each case on 100 parts by weight crosslinkable composition.

As adhesion promoters (v), employed if desired, it is possible to use all adhesion promoters which have also been used to date in condensation-crosslinkable compositions. Examples of adhesion promoters (v) are silanes having hydrolyzable groups and SiC-bonded vinyl, acryloyloxy, methacryloyloxy, epoxy, acid anhydride, acid, ester or ether groups, and the partial hydrolyzate and cohydrolyzate thereof.

As adhesion promoters (v) it is preferred to employ 3-aminopropyltriethoxysilane, 3-(2-aminoethyl)aminopropyltrimethoxysilane, 3-aminopropyltrimethoxysilane, and 3-(2-aminoethyl)-aminopropyltriethoxysilane, particular preference being given to 3-aminopropyltriethoxysilane.

If the compositions of the invention contain adhesion promoters (v), the amounts involved are preferably 0.01 to 5 parts by weight, more preferably 0.5 to 4 parts by weight, based in each case on 100 parts by weight crosslinkable composition.

Examples of further substances (vi) are plasticizers, such as trimethylsilyl-terminated polydimethylsiloxanes and hydrocarbons having about 16 to 30 carbon atoms, stabilizers, such as 2-ethylhexyl phosphate, octylphosphonic acid, polyethers, antioxidants, flame retardants, such as phosphoric esters, photostabilizers (light stabilizers), and pigments, such as titanium dioxide, iron oxides.

The further substances (vi), employed if desired, are preferably plasticizers, such as trimethylsilyl-terminated polydimethylsiloxanes and hydrocarbons having about 16 to 30 carbon atoms, stabilizers, such as 2-ethylhexyl phosphate, octylphosphonic acid, polyethers, flame retardants, such as phosphoric esters, and pigments, such as titanium dioxide iron oxides, particular preference being given to plasticizers and stabilizers.

If constituent (vi) is employed, the amounts involved are preferably 0.01 to 30 parts by weight, more preferably 0.05 to 25 parts by weight, based in each case on 100 parts by weight crosslinkable composition.

If desired, it is possible for the crosslinkable compositions of the invention to comprise crosslinkable polymers (vii), such as organopolysiloxanes having reactive end groups. Examples of crosslinkable siloxanes of this kind are α,ω-dihydroxypolydimethylsiloxanes and α,ω-bis(dimethoxymethyl-silyl)-terminated polydimethylsiloxanes.

The component (vii) used if desired in the crosslinkable compositions of the invention preferably comprises polydiorganosiloxanes having at least one OH group or one hydrolyzable group at the chain ends, more preferably polydimethylsiloxanes having at least one OH group or one hydrolyzable group at the chain ends, and especially α,ω-dihydroxypolydimethylsiloxanes or α,ω-bis(dimethoxymethyl-silyl)-terminated polydimethylsiloxanes having a viscosity of 100 to 500 000 mPas.

The crosslinkable compositions of the invention preferably contain component (vii). This constituent is used with preference to adjust the processing properties, such as viscosity, skinning time or potlife, for example.

If component (vii) is used, the amounts involved are preferably 1 to 50 parts by weight, more preferably 2 to 25 parts by weight, based in each case on 100 parts by weight crosslinkable composition.

The individual constituents of the crosslinkable compositions of the invention may in each case represent one kind of such a constituent or else a mixture of at least two different kinds of such constituents.

In particular the compositions of the invention include no further constituents apart from component (i), if desired (ii), (iii), (iv), (v), (vi), and (vii).

The crosslinkable compositions of the invention are prepared using methods that are known to the skilled worker, such as by means of extruders, compounders, roll mills, dynamic or static mixers, for example. The compositions of the invention can be prepared continuously or batchwise. Preference is given to their continuous preparation.

The typical water content of the air is preferably sufficient for the crosslinking of the compositions of the invention. The crosslinking of the compositions of the invention takes place preferably at room temperature. Alternatively, if desired, it can be carried out at temperatures higher or lower than room temperature, such as at −5 to 15° C. or at 30 to 50° C. and by means of water concentrations that exceed the normal water content of the air, for example. Crosslinking is carried out preferably at a pressure of 100 to 1100 hPa, in particular at the pressure of the surrounding atmosphere, i.e., about 900 to 1100 hPa.

The present invention further provides shaped articles produced by crosslinking the compositions of the invention.

The compositions of the invention have the advantage that they are easy to prepare and easy to handle when processing.

The compositions of the invention have the advantage of a high storage stability.

The compositions of the invention prepared using type A siloxanes of the invention have the advantage that they can be used to produce shaped articles having a particularly low stress at 100% extension, without the need to handle very high-viscosity polymers.

The compositions of the invention prepared using type A siloxanes of the invention have the advantage, moreover, that they can be used to produce shaped articles having a particularly low stress at 100% extension, without the need to handle very high-viscosity compositions.

The compositions of the invention prepared using type B siloxanes of the invention have the advantage that they can be used to produce shaped articles having a particularly low stress at 100% extension, which, furthermore, have permanent biostatic properties, which for a long time prevent, for example, the shaped articles being destroyed by microorganisms.

In the examples described below, all viscosity figures relate to a temperature of 25° C. Unless indicated otherwise, the examples below are carried out at the pressure of the surrounding atmosphere, i.e., about 1000 hPa, and at room temperature, i.e., at about 23° C., or at a temperature which comes about when the reactants are combined at room temperature without additional heating or cooling, and also at a relative atmospheric humidity of about 50%. Furthermore, all parts and percentages, unless indicated otherwise, are by weight.

The Shore A hardness is determined in accordance with DIN (Deutsche Industrie Norm [German Industry Standard]) 53505 (August 2000 version).

Tensile strength, breaking extension, and modulus (stress at 100% extension) were determined in accordance with DIN 53504 (May 1994 version) on specimens having the S2 form.

Me below stands for methyl radical, and Vi for vinyl radical.

### EXAMPLE 1

A mixture of 350 g of an α,ω-dihydroxypolydimethylsiloxane having a viscosity of 350 000 mPas (available from Wacker-Chemie GmbH, Germany under the name “Polymer FD 350”) and 200 g of an α,ω-bis(trimethylsiloxy)polydimethylsiloxane having a viscosity of 10 mPas (available from Wacker-Chemie GmbH, Germany under the name “Ö1 AK 10”), which had a mixed viscosity of 38 000 mPas, was mixed with 0.5 g of bis(methoxydimethylsilylmethyl)amine. This formed a mixture of a type A siloxane having the formula HO[(SiMe₂O)₃₀₋₁₀₀₀(SiMe₂CH₂NHCH₂SiMe₂O)₁₋₂]₁₋₅(SiMe₂O)₃₀₋₁₀₀₀H with the diluent α,ω-bis(trimethylsiloxy)polydimethylsiloxane, having a mixed viscosity of 272 000 mPas. This polymer mixture was subsequently admixed with 12.5 g of methyltrimethoxysilane, 6.25 g of vinyltrimethoxysilane, and 0.25 g of zinc acetylacetonate. This mixture was left to stand at room temperature for 12 hours. In the course of this time the polymer specified above gave rise to the formation of a polymer mixture of the formulae
(MeO)₂MeSiO[(SiMe₂O)₃₀₋₁₀₀₀(SiMe₂CH₂NHCH₂SiMe₂O)₁₋₂]₁₋₅(SiMe₂O)₃₀₋₁₀₀₀SiMe(OMe)₂,
(MeO)₂ViSiO[(SiMe₂O)₃₀₋₁₀₀₀(SiMe₂CH₂NHCH₂SiMe₂O)₁₋₂]₁₋₅(SiMe₂O)₃₀₋₁₀₀₀SiMe(OMe)₂, and
(MeO)₂ViSiO[(SiMe₂O)₃₀₋₁₀₀₀(SiMe₂CH₂NHCH₂SiMe₂O)₁₋₂]₁₋₅(SiMe₂O)₃₀₋₁₀₀₀SiVi(OMe)₂.

The resulting polymer mixture was then admixed with 5.5 g of 3-aminopropyltriethoxysilane, 5.25 g of a methyltrimethoxysilane hydrolyzate having on average 10 silicon atoms per molecule, 4.0 g of 3-aminopropyltrimethoxysilane, 0.875 g of ocytlphosphonic acid, 35.0 g of fumed silica having a specific surface area of 150 m²/g (available from Wacker-Chemie GmbH, Germany under the name HDK® V15), 175 g of calcium carbonate (available under the name “Saxolith 2HE” from GEOMIN Erzgebirgische Kalkwerke GmbH, D-09514 Lengefeld), and 2.0 g of a tin catalyst, obtainable by reacting 4 parts of tetraethoxysilane with 2.2 parts of dibutyltin diacetate.

The resulting crosslinkable composition was dispensed into moisture-tight containers.

The resulting composition was used to produce specimens, by applying the composition as a layer 2 mm thick to a polyethylene base and then crosslinking the system for 7 days at 23° C. and 50% relative humidity. Subsequently, test specimens with the S2 form of DIN 53504 were produced from these plates by punching.

The specimens thus produced were investigated with regard to their mechanical values. The results are found in Table 1.

### COMPARATIVE EXAMPLE 1 (C1)

The experiment of Example 1 was repeated, but omitting the 0.5 g of bis(methoxydimethylsilylmethyl)amine.

The resulting composition was used to produce specimens, by applying the composition as a layer 2 mm thick to a polyethylene base and then crosslinking the system for 7 days at 23° C. and 50% relative humidity. Subsequently, test specimens with the S2 form of DIN 53504 were produced from these plates by punching.

The specimens thus produced were investigated with regard to their mechanical values. The results are found in Table 1.

### EXAMPLE 2

A mixture of 350 g of an α,ω-dihydroxypolydimethylsiloxane having a viscosity of 80 000 mPas (available from Wacker-Chemie GmbH, Germany under the name “Polymer FD 80”) and 200 g of an α,ω-bis(trimethylsiloxy)polydimethylsiloxane having a viscosity of 10 mPas (available from Wacker-Chemie GmbH, Germany under the name “Ö1 AK 10”), which had a mixed viscosity of 18 000 mPas, was mixed with 0.5 g of bis(methoxydimethylsilylmethyl)amine. This formed a mixture of a type A siloxane having the formula HO[(SiMe₂O)₃₀₋₁₀₀₀(SiMe₂CH₂NHCH₂SiMe₂O)₁₋₂]₁₋₅(SiMe₂O)₃₀₋₁₀₀₀H with the diluent α,ω-bis(trimethylsiloxy)polydimethylsiloxane, having a mixed viscosity of 89 000 mPas. This polymer mixture was subsequently admixed with 12.5 g of methyltrimethoxysilane, 6.25 g of vinyltrimethoxysilane, and 0.25 g of zinc acetylacetonate. This mixture was left to stand at room temperature for 12 hours. In the course of this time the polymer specified above gave rise to the formation of a polymer mixture of the formulae
(MeO)₂MeSiO[(SiMe₂O)₃₀₋₁₀₀₀(SiMe₂CH₂NHCH₂SiMe₂O)₁₋₂]₁₋₅(SiMe₂O)₃₀₋₁₀₀₀SiMe(OMe)₂,
(MeO)₂ViSiO[(SiMe₂O)₃₀₋₁₀₀₀(SiMe₂CH₂NHCH₂SiMe₂O)₁₋₂]₁₋₅(SiMe₂O)₃₀₋₁₀₀₀SiMe(OMe)₂, and
(MeO)₂ViSiO[(SiMe₂O)₃₀₋₁₀₀₀(SiMe₂CH₂NHCH₂SiMe₂O)₁₋₂]₁₋₅(SiMe₂O)₃₀₋₁₀₀₀SiVi(OMe)₂.

The resulting polymer mixture was then admixed with 5.5 g of 3-aminopropyltriethoxysilane, 5.25 g of a methyltrimethoxysilane hydrolyzate having on average 10 silicon atoms per molecule, 4.0 g of 3-aminopropyltrimethoxysilane, 0.875 g of ocytlphosphonic acid, 35.0 g of fumed silica having a specific surface area of 150 m²/g (available from Wacker-Chemie GmbH, Germany under the name HDK® V15), 175 g of calcium carbonate (available under the name “Saxolith 2HE” from GEOMIN Erzgebirgische Kalkwerke GmbH, D-09514 Lengefeld), and 2.0 g of a tin catalyst, obtainable by reacting 4 parts of tetraethoxysilane with 2.2 parts of dibutyltin diacetate.

The resulting crosslinkable composition was dispensed into moisture-tight containers.

The resulting composition was used to produce specimens, by applying the composition as a layer 2 mm thick to a polyethylene base and then crosslinking the system for 7 days at 23° C. and 50% relative humidity. Subsequently, test specimens with the S2 form of DIN 53504 were produced from these plates by punching.

The specimens thus produced were investigated with regard to their mechanical values. The results are found in Table 1.

### COMPARATIVE EXAMPLE 2 (C2)

The experiment of Example 2 was repeated, but omitting the 0.5 g of bis(methoxydimethylsilylmethyl)amine.

The resulting composition was used to produce specimens, by applying the composition as a layer 2 mm thick to a polyethylene base and then crosslinking the system for 7 days at 23° C. and 50% relative humidity. Subsequently, test specimens with the S2 form of DIN 53504 were produced from these plates by punching.

The specimens thus produced were investigated with regard to their mechanical values. The results are found in Table 1.

### EXAMPLE 3

A mixture of 350 g of an α,ω-dihydroxypolydimethylsiloxane having a viscosity of 80 000 mPas (available from Wacker-Chemie GmbH, Germany under the name “Polymer FD 350”) and 200 g of an α,ω-bis(trimethylsiloxy)polydimethylsiloxane having a viscosity of 10 mPas (available from Wacker-Chemie GmbH, Germany under the name “Ö1 AK 10”), which had a mixed viscosity of 18 000 mPas, was mixed with 3.0 g of bis(methoxydimethylsilylmethyl)amine. This formed a mixture of a type A siloxane having the formula MeOSiMe₂CH₂NHCH₂SiMe₂O[(SiMe₂O)₃₀₋₁₀₀₀(SiMe₂CH₂NHCH₂SiMe₂O)₁₋₂]₁₋₅(SiMe₂O)₃₀₋₁₀₀₀SiMe₂CH₂NHCH₂SiMe₂OMe with the diluent α,ω-bis(trimethylsiloxy)polydimethylsiloxane, having a mixed viscosity of 10⁶ mPas. This polymer mixture was subsequently admixed with 12.5 g of methyltrimethoxysilane, 6.25 g of vinyltrimethoxysilane, and 0.25 g of zinc acetylacetonate. This mixture was left to stand at room temperature for 12 hours.

The resulting polymer mixture was then admixed with 5.5 g of 3-aminopropyltriethoxysilane, 5.25 g of a methyltrimethoxysilane hydrolyzate having on average 10 silicon atoms per molecule, 4.0 g of 3-aminopropyltrimethoxysilane, 0.875 g of ocytlphosphonic acid, 35.0 g of fumed silica having a specific surface area of 150 m²/g (available from Wacker-Chemie GmbH, Germany under the name HDK® V15), 175 g of calcium carbonate (available under the name “Saxolith 2HE” from GEOMIN Erzgebirgische Kalkwerke GmbH, D-09514 Lengefeld), and 2.0 g of a tin catalyst, obtainable by reacting 4 parts of tetraethoxysilane with 2.2 parts of dibutyltin diacetate.

The resulting crosslinkable composition was dispensed into moisture-tight containers.

The resulting composition was used to produce specimens, by applying the composition as a layer 2 mm thick to a polyethylene base and then crosslinking the system for 7 days at 23° C. and 50% relative humidity. Subsequently, test specimens with the S2 form of DIN 53504 were produced from these plates by punching.

The specimens thus produced were investigated with regard to their mechanical values. The results are found in Table 1.

### EXAMPLE 4

A mixture of 294 g of an α,ω-dihydroxypolydimethylsiloxane having a viscosity of 80 000 mPas (available from Wacker-Chemie GmbH, Germany under the name “Polymer FD 80”), 105 g of an α,ω-bis(trimethylsiloxy)polydimethylsiloxane having a viscosity of 1000 mPas (available from Wacker-Chemie GmbH, Germany under the name “Weichmacher [plasticizer] 1000”) and 61 g of an aliphatic hydrocarbon mixture (available commercially under the name “Hydroseal G400H” from TotalFinaElf Deutschland GmbH), was mixed with 0.2 g of bis(methoxydimethylsilylmethyl)amine in solution in 1.8 g of the aforementioned aliphatic hydrocarbon mixture. This formed a mixture of a type A siloxane having the formula HO[(SiMe₂O)₃₀₋₁₀₀₀(SiMe₂CH₂NHCH₂SiMe₂O)₁₋₂]₁₋₅(SiMe₂O)₃₀₋₁₀₀₀H. This polymer mixture was subsequently admixed with 20.0 g of ethyltriacetoxysilane and 1.84 g of di-tert-butyldiacetoxy-silane, and the components were mixed for 5 minutes. In the course of this time the polymer specified above gave rise to the formation of a polymer of the formula (MeCOO)₂EtSiO[(SiMe₂O)₃₀₋₁₀₀₀(SiMe₂CH₂NHCH₂SiMe₂O)₁₋₂]₁₋₅(SiMe₂O)₃₀₋₁₀₀₀SiEt(OOCMe)₂. Finally, 42.0 g of fumed silica having a specific surface area of 150 m²/g (available from Wacker-Chemie GmbH, Germany under the name HDK® V15) and 0.052 g of dibutyltin diacetate were added and mixed in homogeneously for 10 minutes. Subsequently the mixture was mixed for a further 15 minutes under a pressure of approximately 100 mbar. The resulting crosslinkable composition was dispensed into moisture-tight containers.

The resulting composition was used to produce specimens, by applying the composition as a layer 2 mm thick to a polyethylene base and then crosslinking the system for 7 days at 23° C. and 50% relative humidity. Subsequently, test specimens with the S2 form of DIN 53504 were produced from these plates by punching.

The specimens thus produced were investigated with regard to their mechanical values. The results are found in Table 1.

TABLE 1

| | | Tensile | Breaking | Stress at 100% |
|---|---|---|---|---|
| | Hardness | strength | extension | elongation |
| Examples | [ShoreA] | [MPa] | [%] | [MPa] |
| 1 | 16 | 1.25 | 560 | 0.26 |
| C1 | 22 | 1.36 | 465 | 0.31 |
| 2 | 18 | 1.31 | 482 | 0.30 |
| C2 | 17 | 1.48 | 421 | 0.39 |
| 3 | 19 | 1.09 | 464 | 0.28 |
| 4 | 15 | 1.15 | 792 | 0.21 |

### EXAMPLE 5

### Oligomerization of 1-(methoxydimethylsilyl)-N-[(methoxydimethylsilyl)methyl]-N-methyl-methylamine

211.9 g of 1-(methoxydimethylsilyl)-N-[(methoxydimethylsilyl)-methyl]-N-methyl-methylamine were introduced as an initial charge and cooled to +10° C. Subsequently 10.8 g of water were added slowly dropwise with thorough stirring, the temperature of the reaction mixture rising to about 25° C. The mixture was stirred at room temperature for 1 hour and at 50° C. for a further hour. Thereafter the methanol formed in the course of the reaction, and all volatile constituents, were removed by distillation at 50° C. under reduced pressure (p<1 mbar). This gave 178 g of a colorless, virtually crystal-clear oil having a viscosity of 61 mm²/s and an amine content of 4.85 mmol/g, corresponding to the approximate composition MeO—SiMe₂-CH₂—N(Me)—CH₂—[SiMe₂OSiMe₂-CH₂—N(Me)—CH₂—]_{1.9}—SiMe₂-OMe.

Co-Condensation with Polydimethylsiloxane

A mixture consisting of 118.8 g of 1-(methoxydimethylsilyl)-N-[(methoxydimethylsilyl)methyl]-N-methylmethylamine oligomer and 2973.2 g of a polydimethylsiloxane having a viscosity of 195 mm²/s and a SiOH content of 26.9 mmol/100 g was heated to 80° C. with stirring and held at this temperature for 2 hours. Subsequently the methanol formed in the course of the reaction, and all volatile constituents, were removed by distillation at 80° C. under reduced pressure (p<10 mbar). This gave a colorless, clear oil having a viscosity of 1135 mm²/s, an amine content of 0.188 mmol/g and an SiOH content of 6.45 mmol/100 g.

N-Alkylation (Quaternization) of the Co-Condensate

3000 g of the above PDMS-aminosilane co-condensate were charged to a 5 L stirrer and cooled to 10° C. Subsequently a solution of 105.5 g of methyl p-toluenesulfonate in 600 g of tetrahydrofuran (THF) was added, the reaction mixture warming slowly to room temperature. The alkylation was completed by stirring at room temperature for 1 hour and at 50° C. for 30 minutes. Subsequently all of the volatile constituents were removed at 50° C. by distillation under reduced pressure (p<10 mbar). This gave a highly viscous, pale yellow oil having a viscosity of 1.8·10⁵ mPas and an SiOH content of 6.2 mmol/100 g.

Compounded Formulation

35 g of the polyquaternary polysiloxane thus prepared, 1400 g of an α,ω-dihydroxypolydimethylsiloxane having a viscosity of 80 000 mPas, 600 g of a polydimethylsiloxane having —OSi(CH₃)₃ end groups and a viscosity of 100 mPas, 90 g of ethyltriacetoxysilane and 190 g of a fumed hydrophilic silica having a specific surface area of 150 m²/g were mixed homogeneously under reduced pressure in a planetary mixer. Subsequently 0.5 g of dibutyltin diacetate was added and homogenization was repeated for 5 minutes.

The storage stability was determined by storing a sample in a container impervious to atmospheric moisture at 100° C. for 3 days. There were no changes in either the curing behavior or the appearance of the sample, which is a demonstration of excellent storage stability and yellowing resistance.

The vulcanizate plates produced in the manner indicated were used to produce specimens in accordance with DIN EN ISO 846, which were tested as described in the standard by method B. The resulting growth was zero or minimal (level 0 or 1).

1.-10. (canceled)

11. An organopolysiloxane comprising
at least one unit (a) selected from units (a1) of the formula
O_{1/2}—SiR₂CR¹₂NR²CR¹₂SiR₂—O_{1/2} (I)
and units (a2) of the formula
[O_{1/2}—SiR₂CR¹₂NR³₂CR¹₂SiR₂—O_{1/2}]^{⊕}.X⁻ (VIII);
optionally, units of the formula
O_{1/2}—SiR₂—O_{1/2} (II);
optionally, units of the formula
R⁴O_{1/2} (III);
optionally, units of the formula
R⁵ₙSiR₃₋ₙ—O_{1/2} (IV);
optionally, units of the formula
O_{1/2}SiR₂(CH₂)ₐNR³₃^{⊕}.X⁻ (V);
and, optionally, units of the formula
O_{1/2}SiR₂(CH₂)_{b}NR²₂ (VI)
where
R each are identical or different and are monovalent, SiC-bonded, optionally substituted hydrocarbon radicals,
R¹ each are identical or different and are monovalent organic radicals or hydrogen atoms,
R² each are identical or different and are monovalent organic radicals or hydrogen atoms,
R³ each are identical or different and are monovalent organic radicals or hydrogen atoms,
R⁴ each are identical or different and are hydrogen atom or monovalent, optionally substituted hydrocarbon radicals,
R⁵ each are identical or different and are monovalent hydrolyzable organic radicals attached via oxygen atom or nitrogen atom to silicon atoms,
n is 2 or 3,
a is an integer from 1 to 6,
b is an integer from 1 to 6, and
X⁻ each are identical or different and are an organic or inorganic anions, with the proviso that in the case of an organopolysiloxane containing no unit of the formula (VIII) there is additionally at least one unit of the formula (II) present, and in the case of an organopolysiloxane containing no unit of the formula (I) there is additionally at least one unit present selected from units of the formula (III) and of the formula (IV).

12. The organopolysiloxane of claim 11, containing no units of the formula (VIII).

13. The organopolysiloxane of claim 11, containing at least one unit of the formula (VIII).

14. The organopolysiloxane of claim 11, of the formula
E-[(—O—SiR₂)ₒ—(O—SiR₂CR¹₂NR²CR¹₂SiR₂)ₚ]ᵣ(O—SiR₂)_{q}—OE (VII)
where
E each are identical or different and has one of the definitions specified for R⁴, or is a radical (R⁵)ₙ—SiR₃—,
o each are identical or different and is 0 or an integer from 1 to 3000,
q each are 0 or an integer from 1 to 3000,
p each are identical or different and are an integer from 1 to 20, and
r each are an integer from 1 to 20, and
with the proviso that the sum o+q is greater than or equal to 1.

15. The organopolysiloxane of claim 12, having a viscosity of 10⁵ to 10⁸ mPas at 25° C.

16. The organopolysiloxane of claim 14, having a viscosity of 10⁵ to 10⁸ mPas at 25° C.

17. The organopolysiloxane of claim 11, comprising a substantially linear siloxane comprising at least one unit of the formula (VIII), at least one unit of the formula (III), and, optionally, units of formulae (II), (IV), (V), and (VI).

18. The organopolysiloxane of claim 12, comprising a substantially linear siloxane comprising at least one unit of the formula (VIII), at least one unit of the formula (III), and, optionally, units of formulae (II), (IV), (V), and (VI)

19. The organopolysiloxane of claim 13, comprising a substantially linear siloxane comprising at least one unit of the formula (VIII), at least one unit of the formula (III), and, optionally, units of formulae (II), (IV), (V), and (VI).

20. The organopolysiloxane of claim 13, having a viscosity of 10² to 10⁵ mPas at 25° C.

21. The organopolysiloxane of claim 17, having a viscosity of 10² to 10⁵ mPas at 25° C.

22. A crosslinkable composition comprising at least one organopolysiloxanes (i) of claim 11, comprising
at least one unit (a) selected from units (a1) of the formula
O_{1/2}—SiR₂CR¹₂NR²CR¹₂SiR₂—O_{1/2} (I)
and units (a2) of the formula
[O_{1/2}—SiR₂CR¹₂NR³₂CR¹₂SiR₂—O_{1/2}]^{⊕}.X⁻ (VIII);
optionally, units of the formula
O_{1/2}—SiR₂—O_{1/2} (II);
optionally, units of the formula
R⁴O_{1/2} (III);
optionally, units of the formula optionally, units of the formula
O_{1/2}SiR₂(CH₂)ₐNR³₃^{⊕}X⁻ (V);
and, optionally, units of the formula
O_{1/2}SiR₂(CH₂)_{b}NR²₂ (VI)
where
R each are identical or different and are monovalent, SiC-bonded, optionally substituted hydrocarbon radicals,
R¹ each are identical or different and are monovalent organic radicals or hydrogen atoms,
R² each are identical or different and are monovalent organic radicals or hydrogen atoms,
R³ each are identical or different and are monovalent organic radicals or hydrogen atoms,
R⁴ each are identical or different and are hydrogen atom or monovalent, optionally substituted hydrocarbon radicals,
R⁵ each are identical or different and are monovalent hydrolyzable organic radicals attached via oxygen atom or nitrogen atom to silicon atoms,
n is 2 or 3,
a is an integer from 1 to 6,
b is an integer from 1 to 6, and
X⁻ each are identical or different and are an organic or inorganic anions, with the proviso that in the case of an organopolysiloxane containing no unit of the formula (VIII) there is additionally at least one unit of the formula (II) present, and in the case of an organopolysiloxane containing no unit of the formula (I) there is additionally at least one unit present selected from units of the formula (III) and of the formula (IV).

23. The crosslinkable composition of claim 22, comprising
(i) nitrogen-containing organopolysiloxanes;
(ii) optionally crosslinkers;
(iii) optionally one or more condensation catalysts;
(iv) optionally filler;
(v) optionally one or more adhesion promoters;
(vi) optionally further substances selected from the group containing plasticizers, stabilizers, antioxidants, flame retardants, photostabilizers, and pigments; and
(vii) optionally crosslinkable polymers different from (i).

24. The crosslinkable composition of claim 22, comprising
(i) nitrogen-containing organopolysiloxanes;
(ii) crosslinkers;
(iii) one or more condensation catalysts;
(iv) filler;
(v) one or more adhesion promoters;
(vi) further substances selected from the group containing plasticizers, stabilizers, antioxidants, flame retardants, photostabilizers, and pigments.

25. A shaped article produced by crosslinking the composition of claim 22.

26. A moisture curing one-component sealant composition comprising a crosslinkable composition of claim 22, said composition, when cured, exhibiting a stress at 100% elongation which is less than a comparable composition containing organopolysiloxanes containing no units (I) and (VIII).

27. The moisture curing one-component sealant composition of claim 26, wherein said organopolysiloxane (i) contains quaternary nitrogen-containing units (VIII), said sealant following curing exhibiting antimicrobial properties.
